(19) United States
(12) Patent Application Publication
(10) Pub. No.: US 2022/0075628 A1
(43) Pub. Date: Mar. 10, 2022

(54) System and Method for Supervising Processes Among Embedded Systems

(71) Applicant: DEKA Products Limited Partnership, Manchester, NH (US)

(72) Inventor: Paul L. Adams, Dover, NH (US)

(21) Appl. No.: 17/470,446

(22) Filed: Sep. 9, 2021

Related U.S. Application Data
(60) Provisional application No. 63/075,882, filed on Sep. 9, 2020.

(51) Int. Cl. G06F 9/4401; G06F 21/51; G06F 21/55

(52) U.S. Cl. CPC G06F 9/442; G06F 21/552; G06F 21/51

(57) ABSTRACT

System and method for ensuring the integrity of multiple processes executing cooperatively on a plurality of embedded computers. The system can access at least one configuration file that can include the processes that need to be started, monitored, and stopped on the embedded computer. The configuration file can configure executive instances of the executive system to report to an executive prime, if necessary. The executive prime can, for example, communicate with and control aspects of the executive instances from each embedded computer, such as cooperative shutdowns under pre-selected conditions.

### CROSS REFERENCE TO RELATED APPLICATIONS

This utility patent application claims the benefit of U.S. Provisional Patent Application Ser. No. 63/075,882 filed Sep. 9, 2020, entitled System and Method for Supervising Processes (Attorney Docket # AA369), which is incorporated herein by reference in its entirety.

### BACKGROUND

Process management involves various tasks like creation, scheduling, and termination of processes. A process is a program that is under execution, which is an important part of modern-day operating systems. The operating system allocates resources that enable processes to share and exchange information. It also protects the resources of each process from competing demands, and allows synchronization among processes. The operating system manages the running processes of the system, and performs tasks like process scheduling and resource allocation.

Multiprocessor systems can simultaneously execute computer instructions on different processors to reduce processing time. Operating systems that support multiple processors take into account the timing involved in making sure that instruction execution is accomplished in an orchestrated sequence to achieve the proper result. Regardless of the orchestration and the specific operating system, the multiple processors are under the control of a single operating system. A more complicated version of multiprocessor systems includes multiple processors each executing under the control of its own operating system. When controlling a device, the activities of the multiple embedded, yet autonomous, systems need to be coordinated. What is needed is a system and method for coordinating the activities of multiple autonomous embedded systems to accomplish control of a device.

### SUMMARY

The executive system and method of the present teachings for ensuring the integrity of multiple processes can, for example, be deployed on a plurality of embedded computers, and can be started on each of the plurality of computers when the embedded system powers on. The executive system can access at least one configuration file that can include the processes that need to be started, monitored, and stopped on the embedded computer. The configuration file can configure executive instances of the executive system to report to an executive prime, if necessary. The executive prime can, for example, communicate with and control aspects of the executive instances from each embedded computer. However, no executive prime is required. The configuration files can include a list of processes that the executive is monitoring, and whether or not a process is deemed essential. The configuration files can include parameters that are unique for each process that is monitored by the executive system.

When an executive instance accesses its configuration files, the executive instance can attempt to start all of the processes for which instructions are included in the configuration files. If one or more of the processes fail to start, and those processes in question are marked essential by the configuration files, then the executive instance will proceed to shutdown mode. If all essential processes start successfully, then the executive instance will transition to a monitoring state.

In the monitoring state, the executive instance can check in on every process it monitors as set out in the configuration files. In some configurations, the executive instance considers a process to be running as long as the process's state has not changed from a running state, and, when required by the associated configuration file, as long as the process continues to provide a timely heartbeat that is lower than a pre-selected timeout threshold. In some configurations, process states can follow Linux conventions and can include, but are not limited to including, running, uninterruptible sleep, interruptible sleep, terminated, and stopped. A process can enter each of these states in a variety of ways. Any type of process state convention can be used to trigger state change activity. Moving from one state to another can be monitored by the executive instance. If at least one of the essential processes is deemed ‘not running’, the executive instance will transition to the shutdown mode.

In shutdown mode, the executive instance can end the processes that are still running on the embedded computer and can self-exit. The executive instance can shut down processes locally by pre-empting the operating system's role in process management. The executive instance can send a shutdown request to a non-local executive which can shut down its local processes. The executive instance can enter shutdown mode for four reasons: (1) if the executive instance detects that an essential process has stopped, (2) if the executive instance receives an indication that the user, for example, enters ctrl+C (referred to, for example, as SIGINT), or a process in the system has sent a termination signal to the executive instance (referred to, for example, as SIGTERM), (3) if the connection between the executive instance and the executive prime has timed out, or (4) if the executive prime has instructed the executive instance to shut down. Conditions (3) and (4) can only cause an entry into shutdown mode if at least one executive prime has been configured.

In some configurations, the executive can manage the processes on clusters of computer nodes at the same time. Executive modes enable the execution of subsets of known and registered processes found in launch files, and a process that is integrated with an executive client can switch modes. For example, a process can switch in an out of a low power mode.

### BRIEF DESCRIPTION OF THE DRAWINGS

The present teachings will be more readily understood by reference to the following description, taken with the accompanying drawings, in which:

FIG. 1A is a schematic block diagram of the system of the present teachings;

FIG. 1B is a pictorial representation of a configuration of embedded systems of the present teachings;

FIGS. 2A-2B are flowcharts of a configuration of the method of the present teachings;

FIG. 3A is a schematic block diagram of the communications classes of a first configuration of the system of the present teachings;

FIG. 3B is a schematic block diagram of the communications classes of a second configuration of the system of the present teachings;

FIG. 4A is a schematic block diagram of the process interaction classes of a first configuration of the system of the present teachings;

FIG. 4B is a schematic block diagram of the process interaction classes of a second configuration of the system of the present teachings;

FIGS. 5A-5D are schematic block diagrams of the process classes of a configuration of the system of the present teachings;

FIG. 6A is a flow diagram of a configuration of the executive state machine of the present teachings;

FIG. 6B is a flow diagram of a configuration of the executive state machine and executive modes of the present teachings;

FIG. 7A is a flow diagram of a configuration of a process tracker system of the present teachings;

FIG. 7B is a schematic block diagram of a configuration of a process tracker system of the present teachings;

FIG. 8 is a schematic block diagram of the class structure of the system of the present teachings; and

FIG. 9 is a communications flow diagram of the process classes of a configuration of the method of the present teachings.

### DETAILED DESCRIPTION

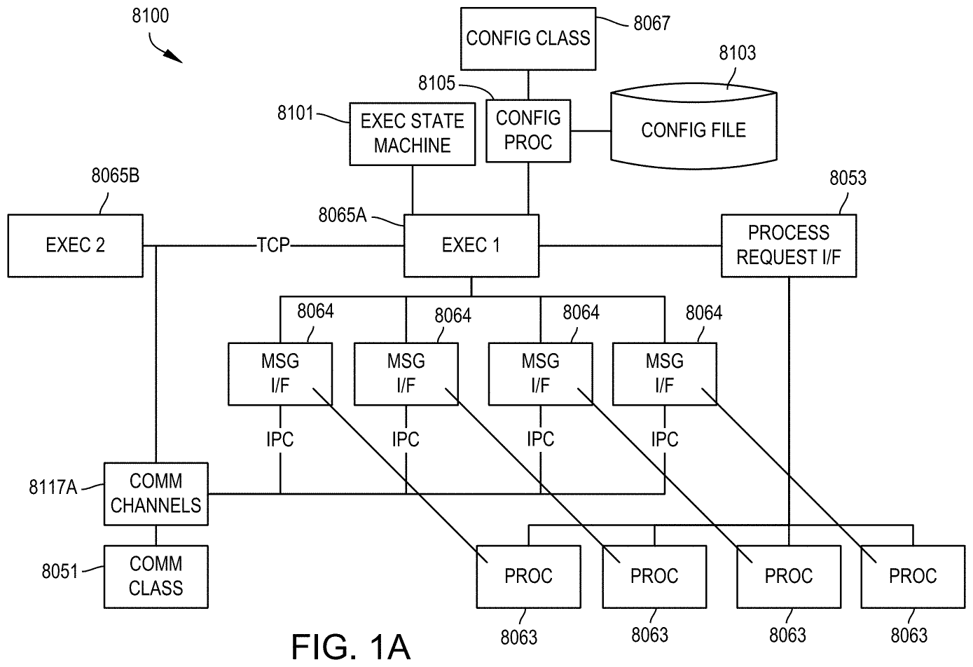

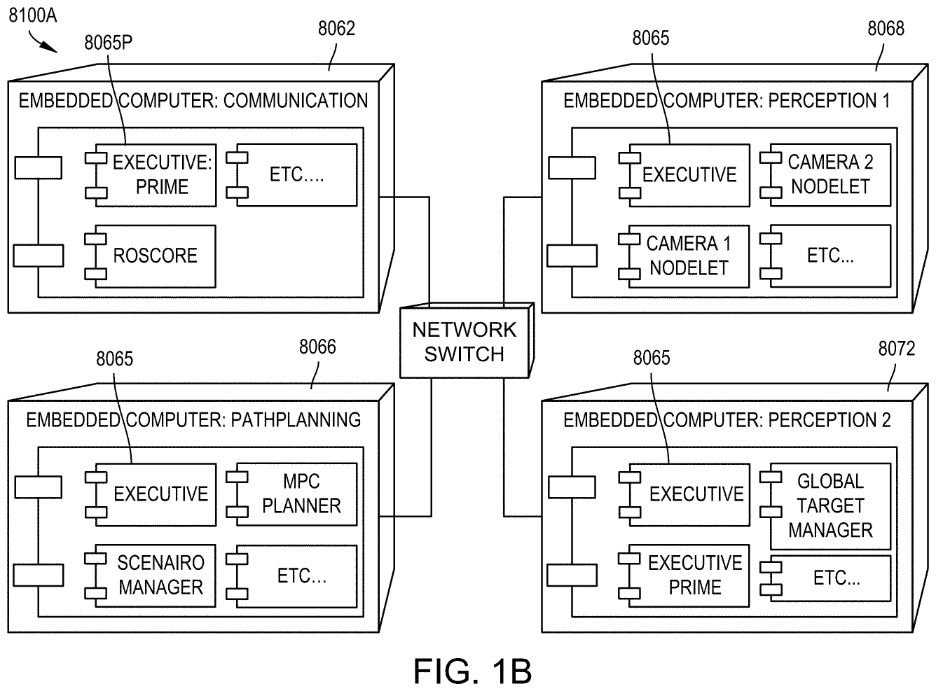

Referring now to FIG. 1A, system 8100 can manage activities among embedded systems. Embedded systems are individual processors executing independent operating systems. Each of the embedded systems can be controlling various aspects of a device, and can advantageously operate cooperatively through the system and method of the present teachings. Operating systems in the embedded systems can be different between embedded systems. For example, one embedded system can be executing under Linux, another can be executing under Android Automotive Operating System, Apple CarPlay, Robotic Operating System, NVIDIA DRIVE′ Operating System, MENTOR NUCLEUS® Operating System, Green Hills INTEGRITY®, Wind River VxWorks, or QNX Neutrino, for example. In some configurations, the device can be an autonomous device, a remotely controlled device, a semi-autonomous system, or any combination of these system types. In particular, each embedded system can include executive 8065A/B that can recognize various processes 8063. Some of processes 8063 can be deemed essential. Executive 8065A can monitor the states of processes 8063 and can inform other executives 8065B of the embedded systems of process state changes. For example, if essential processes have shut down, executive 8065A can inform executive 8065B and can possibly go into an alternate state and/or request shut down of executive 8065B executing on another embedded system. Coordinated activity among the embedded systems can prevent uncontrolled failure in the device.

Continuing to refer to FIG. 1A, processes 8063 can be activated (local processes can be spawned, remote processes can be requested to start) by process request interface 8053 that receives its commands from executive 8065A. Executive 8065A knows which processes 8063 to activate based on information from configuration object 8105 which can access configuration file 8103 to retrieve process data. Executive 8065A can communicate with processes 8063 through message interface 8064. In some configurations, communications class 8051 can enable communications channels 8117A to be activated among processes 8063 using, for example, the interprocess communication (IPC), and among executives 8065A/B using, for example, the transmission control protocol (TCP). Other protocols are contemplated by this description.

Referring now to FIG. 1B, exemplary configuration 8100A of embedded systems can include, for example, but not limited to, communication system 8062, two perception systems 8068/8072, and path planning system 8066. These embedded systems, that can control an autonomous device, each include executive 8065, and each executive 8065 can be configured to be an executive prime 8065P as described herein. The executives are executed along with other processes executed on the embedded computers.

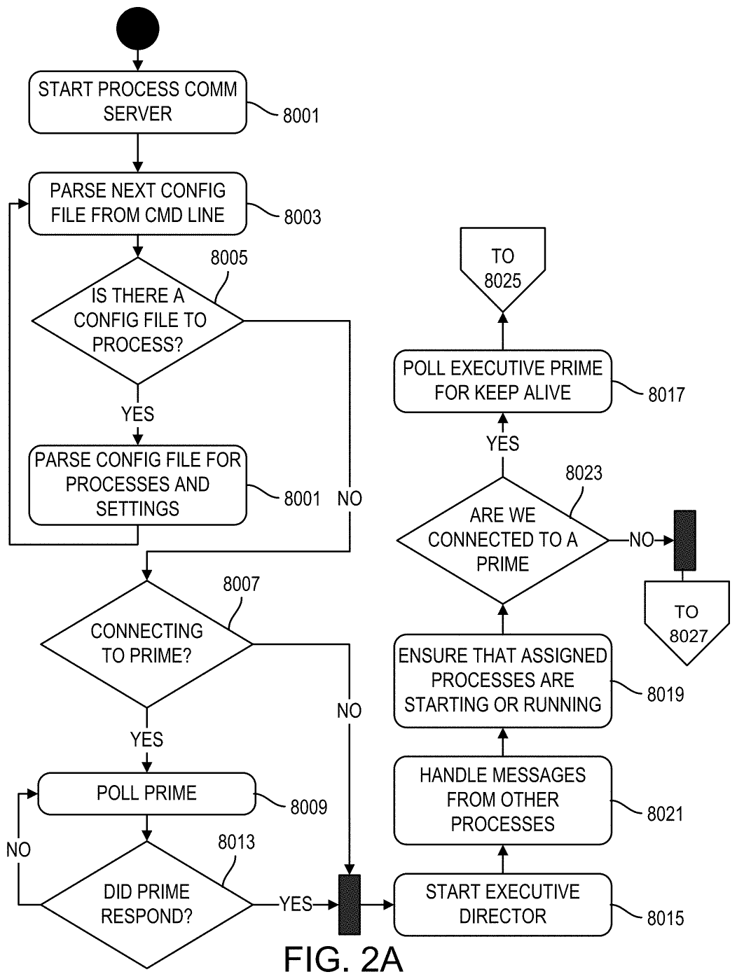

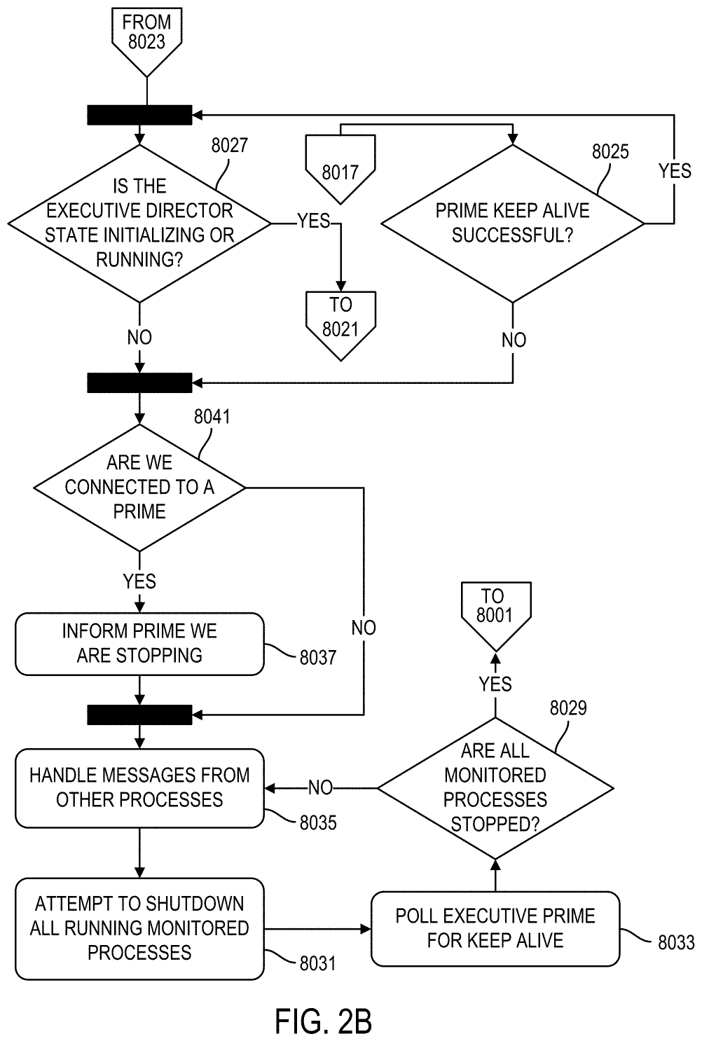

Referring now to FIGS. 2A and 2B in which each embedded system includes an executive instance, when an executive instance is started on an embedded system, the executive instance establishes a communication server to manage messaging among monitored processes and among executive instances executing on embedded systems. The communication server can open 8001 inter-process communications (IPC) channels and transmission control protocol (TCP) channels so that other processes can establish a connection to the communications server. The communications server can open TCP connections to executive instances on the various embedded systems, and can coordinate communications among executive instances. Executive instances executing on other embedded systems that are connected to a particular executive instance can be executive primes. As communications are being established, connections to executive primes and TCP connections to the particular executive instance are not established, nor are any TCP server connections. However, executive instances open IPC connections for processes local to the executive instance to communicate with the executive instance.

Continuing to refer to FIGS. 2A and 2B, an executive instance can, but is not required to, include an association with at least one configuration file and can access 8003 the at least one configuration file. After the executive instance is launched, it can invoke a communication server to open TCP server ports or connect to an executive prime. The executive instance can integrate whatever configuration files it is associated with, if any, consecutively before starting any processes. If 8005 there are more configuration files to process, the executive instance can parse 8011 the configuration file which can denote which processes to start and monitor, how to start them, and the frequency of heartbeat signals to expect from them. The configuration file can indicate if the executive instance should connect to an executive prime or become one. A configuration file can be located on one or more of the embedded systems, or can reside externally to the embedded system. There can be multiple configuration files accessible, either locally or remotely, by any of the plurality of embedded systems. If 8005 there are no more configuration files to process, and if 8007 the configuration files indicate no executive prime to connect to, the executive instance can start 8015 the executive director object. If 8007 the configuration files indicate that there is an executive prime, the executive instance can poll 8009 the executive prime. If 8013 the executive prime responds with a start command, the executive instance can start 8015 the executive director object. If 8013 the executive prime does not respond, the executive instance can continuing polling 8009 the executive prime indefinitely or until a SIGINT or SIGTERM is received. Each associated configuration file can be provided to the executive director object for later exaltation. When a configuration object of a configuration file is exalted, it becomes an executive state machine object ready to start and monitor its defined processes. Each process is represented by a proxy that the executive director can maintain and observe.

Continuing to still further refer to FIGS. 2A and 2B, if 8007 there is no designated executive prime, then when all configuration files are read, any processes started, and the communication server started, the executive instance transitions its executive director object containing all monitoring processes into an initialization state. If 8007 there is a designated executive prime, then the executive process can poll 8009 the executive prime until the executive prime respond the first time. When the executive director object starts 8015, it attempts to exalt all of its configuration objects and then transitions the exalted objects (the executive objects) into the initialization state. The executive director object can, at a later time (until a start message is received from a prime if there is a prime, but otherwise, no delay in starting) try to exalt configuration objects, if any, that are not ready at the current time for exaltation. Configuration objects may not be ready for exalting if, for example, but not limited to, when the configuration object is a robot operating system (ROS) configuration object and a ROScore instance (which must be executing for ROS nodes to communicate) is not executing. Other configuration objects could have other execution prerequisites.

Continuing to refer to FIGS. 2A and 2B, the executive instance executes a run time loop until one of a few different events occurs. During the run time loop, the executive instance processes 8021 incoming requests from the communication server. The number of incoming requests can be limited to prevent an accidental denial of service event. Denial of service events can be caused by, but are not limited to being caused by, monitored processes sending such messages as heartbeat messages and shutdown requests, for example, after the processes are started by the executive. When heartbeat messages are received from a process, that process's proxy's check in time is updated for later review by a hosted process cluster. A hosted process cluster is an object that has one or more processes. The hosted process cluster describes both a configuration object and a state machine. Because a configuration object can morph into a state machine, the term hosted process cluster can be used to describe both. If a shutdown message is received, then the process's proxy is reflected to convey that for later consideration. To enable more efficient execution, the shutdown message is processed at a time when it is convenient to avoid switching between the communications nexus and the state machine. Every time the executive begins executing, messages are flushed, variables are examined and acted upon, and if a shutdown message is awaiting processing, the executive will not process the shutdown message until it has completed all its awaiting tasks.

Referring again to FIGS. 2A and 2B, after the communication server has completed processing messages in its queue, the executive instance directs the executive director object to perform a series of actions on the processes monitored by the executive director object based on the executive state machine's current state, as described herein. In the initializing state the executive state machine will attempt to start all processes and ensure 8019 that all processes are started. When all processes are started, the executive state machine will transition into the monitoring state. If essential processes fail to start, the executive state machine will move into the shutdown state. In the monitoring state the executive state machine verifies that all essential processes are alive. If one or more essential processes is not alive, then the executive state machine transitions to the Shutdown state. If one or more of the executive state machine objects under the executive director object go into the shutdown state, then all of the executive state machine objects under the executive director object also go into shutdown state.

Continuing to refer to FIGS. 2A and 2B, after the executive director object has completed its tasks on the monitored processes, the executive director will then poll 8017 the executive prime if 8023 connected to an executive prime, provided through the configuration files at start up. If 8025 the prime polling is successful, and if 8027 the executive director is either in initializing or running state, the executive director object loops through these last two to three actions indefinitely until one of four events occur. The first event is that the executive director's state is neither initializing or monitoring 8027. The second event is when a SIGINT or SIGTERM is received by the executive instance. The third event is if the executive instance is connected to an executive prime, and if the executive prime process directed the executive instance to shutdown, and the fourth event is if the executive prime process did not reply to the executive instance within a pre-selected time period. If any of these events occur, the executive instance directs the executive director object to transition to shutdown state, and thus the run time loop is ended.

Continuing to refer to FIGS. 2A and 2B, if 8041 there is an executive prime, then the executive instance messages 8037 the executive prime that the executive instance is transitioning to shutdown state. After that, the executive instance executes a second runtime loop. The second runtime loop operates the same way the first runtime loop operates, that is, the second runtime loop includes the same communications server message processing, the same executive director object processing 8035/8031, and the same executive prime heartbeat protocol 8033, if there is an executive prime. The difference between the first runtime loop and the second runtime loop is that the second runtime loop terminates when 8029 the executive director object finishes stopping all monitored processes and transitions to the idle state. When the executive director transitions to idle state, the executive instance will wait in the idle state to start anew or to facilitate the spared processes.

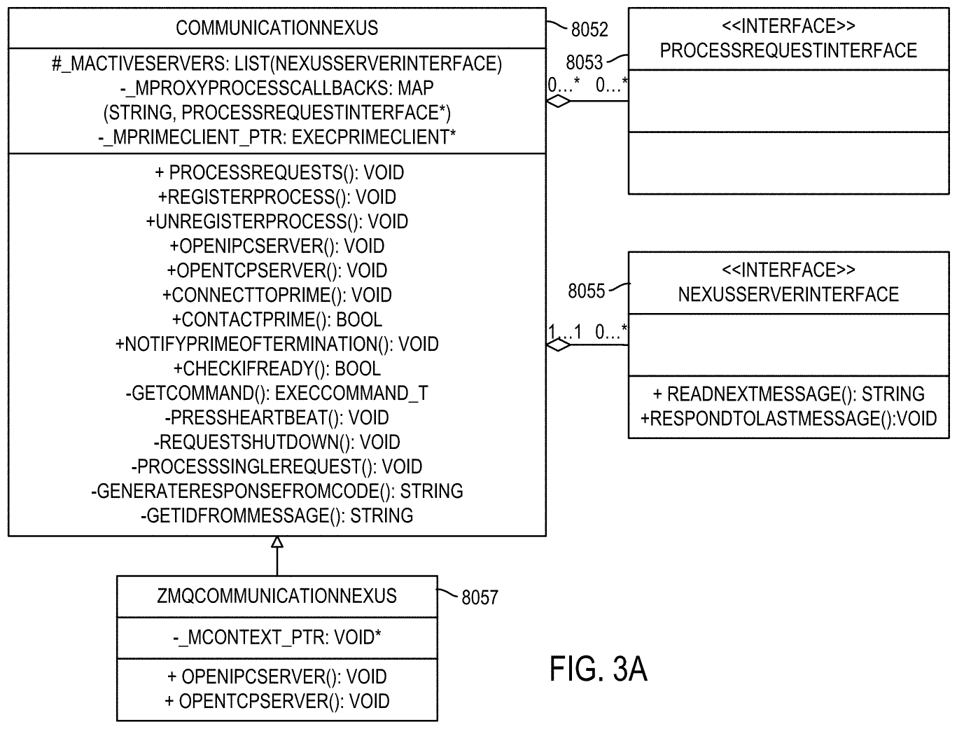

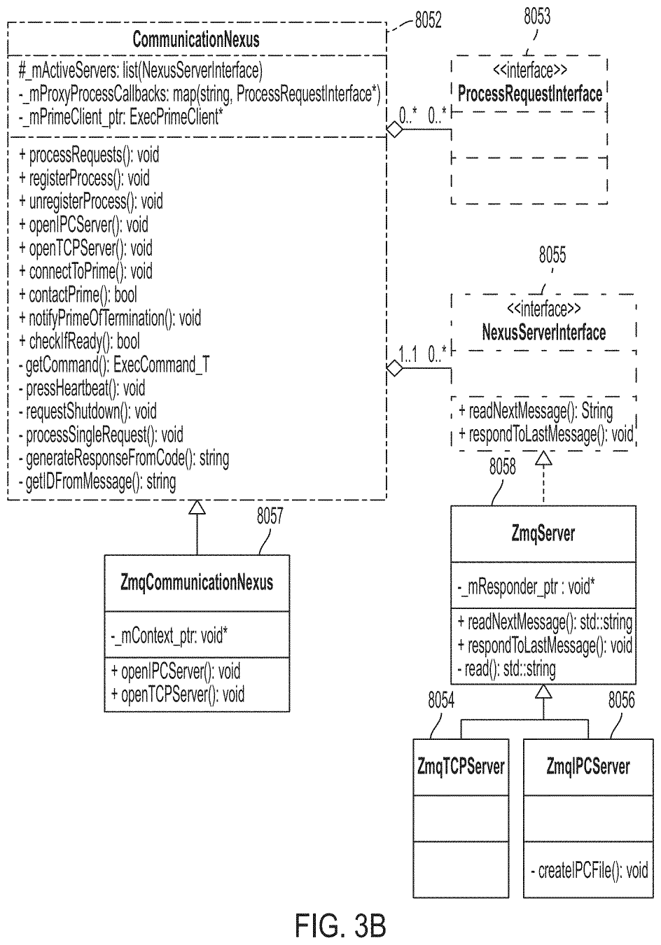

Referring now to FIG. 3A, in an arrangement, communications to and from the executive instance can be managed through a pre-selected class, such as communications nexus class 8052. Communications nexus class 8052 can open and monitor communications channels through a class such as open class 8057. Open class 8057 is a wrapper class that is used to abstract communications from a tool, such as, for example, but not limited to, a protocol for exchanging messages between peers over, for example, TCP. In an arrangement, the tool is ZeroMQ message transport protocol. In some configurations, the communications channels can include, but are not limited to including, TCP and IPC channels. Processes that run locally or remotely on the same hardware can communicate to the executive instance though messaging interface 8055 such as, for example, an IPC nexus server interface. Processes not running on the same CPU as the executive instance can communicate with the executive instance through an abstraction layer that uniformly processes remote and local process communications opened by communications nexus class 8052.

Communications nexus class 8052 can open any number of messaging interfaces 8055, including but not limited to TCP and IPC interfaces. Process objects registered by the executive through the configuration file can be created with, but are not limited to being created with, process request interface 8053. Operating system processes and processes created by the executive are distinct from each other. Process objects associated with the executive can be registered with communications nexus class 8052. When a process communicates though communications nexus class 8052, communications nexus class 8052 will locate the process's registered process object, if it exists, and call the appropriate function according to the message sent by the process. Process request interface 8053 will also instruct communications nexus class 8052 in how to respond to the calling process. In order for a process to communicate to an executive instance, the process can use an executive client applications programming interface (API) described herein.

Referring now to FIG. 3B, in an arrangement, communications to and from the executive instance can be managed through communication nexus class 8052. This class utilizes nexus server interfaces 8055 to open and monitor TCP and IPC channels. Other processes running locally on the same hardware can communicate to the executive instance though an IPC nexus server interface 8058. Processes not running on the same CPU as the executive instance can communicate to the executive instance through a TCP server 8054 opened by communication nexus class 8052. Communication nexus class 8052 can open any number of both TCP and IPC nexus server interfaces 8055. Later, when process objects are created, if they are created with process request interface 8053, then the processes can register themselves with communication nexus class 8052. When an operating system process communicates though communication nexus class 8052, communication nexus class 8052 can locate the process's registered process request interface 8053 object if it exists and call the appropriate function according to the message sent by the operating system process. Process request interface 8053 can instruct communication nexus class 8052 how to respond to the calling process. In some configurations, a process can communicate with an executive through an executive client API, for example.

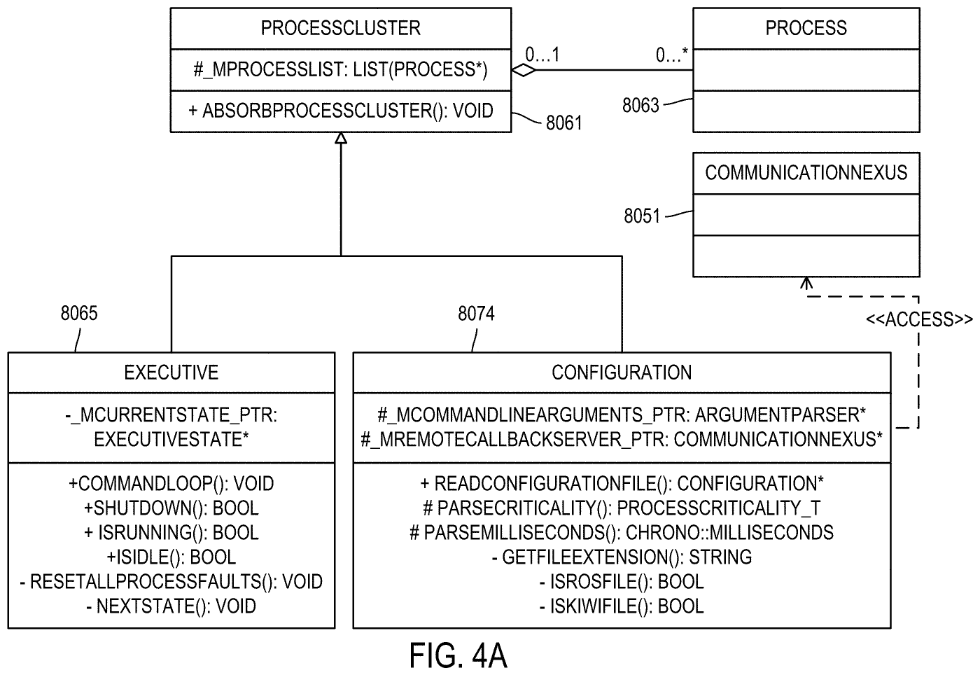

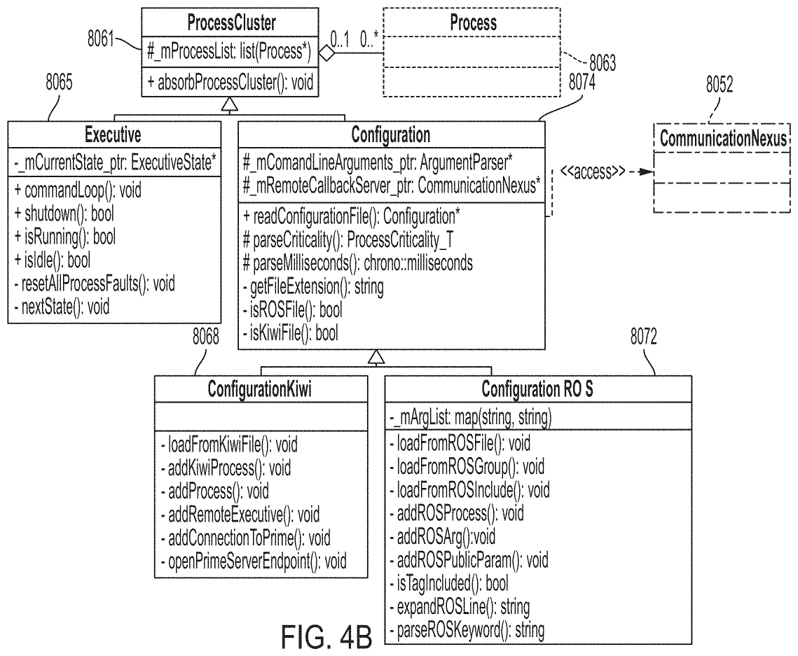

Referring now to FIG. 4A, processes 8063 are created, monitored, and managed by process cluster objects created according to process cluster class 8061. Process cluster objects hold a list of processes 8063 and can entirely absorb other process cluster objects and their processes 8063. Configuration class 8074 is a class of process cluster class 8061 that can create process objects that can read and act upon types of configuration files. For example, one type of configuration object can read and parse ROS launch files and create configuration objects from information in the configuration file such as node tags and XML tags. Another type of configuration object can read custom XML files that are used by the executive instance. During initialization, all configuration files are processed by configuration objects and are then absorbed into one remaining configuration object (exalted into executive object 8065) that holds all of the processes that will be watched by the executive instance. The remaining configuration object is exalted into an executive object which is a state machine described herein. The executive object state machine will run until the end of the life cycle of the executive instance.

Referring now to FIG. 4B, processes 8063 are created, monitored, and managed by process cluster objects from process cluster class 8061. Process cluster objects hold a list of processes 8063 and have the ability to entirely absorb other process cluster objects and their processes 8063. Configuration class 8074 is process cluster class 8061 whose job is to create process objects by reading configuration files. The kind of configuration file is determined by child classes such as, for example, but not limited to, configuration bot class 8068 and configuration ROS class 8072. Configuration ROS class 8068 creates objects able to read and parse ROS launch files and create process objects from the node tags within. Configuration ROS objects 8072 can interpret ROS XML tags and act accordingly. Configuration bot class 8068 can read, for example, custom files, such as, for example, but not limited to, XML files, that are only used by the executive. During initialization, all configuration files are processed by configuration objects and are then absorbed into one remaining configuration object that holds all of the processes that are to be watched by the executive. With one configuration object remaining, an executive object is made and given the last configuration object, giving all the loaded processes to the executive object 8065. The executive object 8065 is a state machine as described herein and will run until the end of the executive process's life cycle.

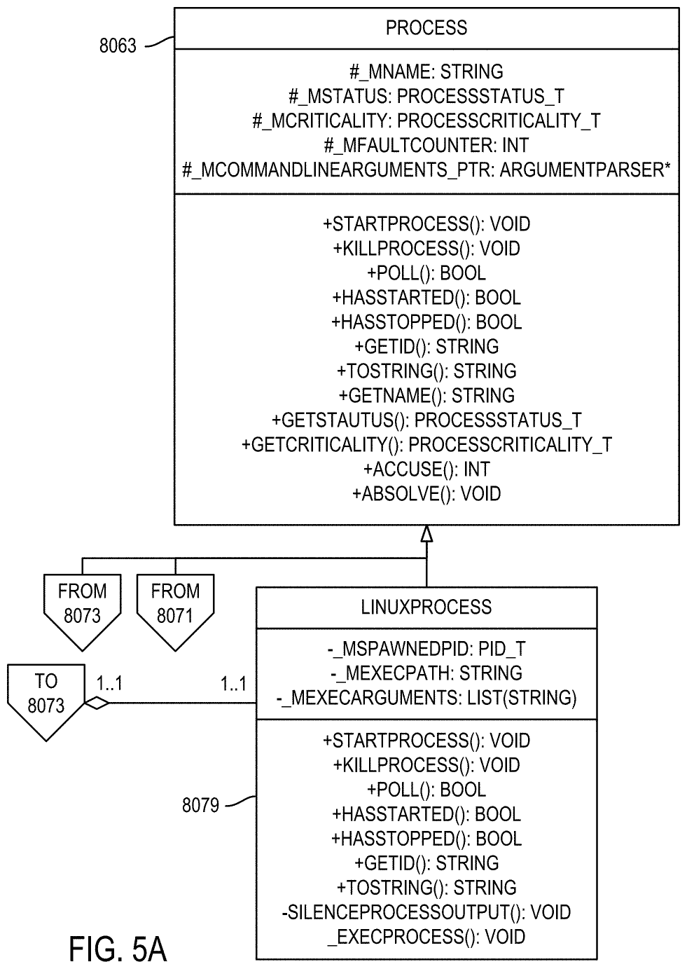

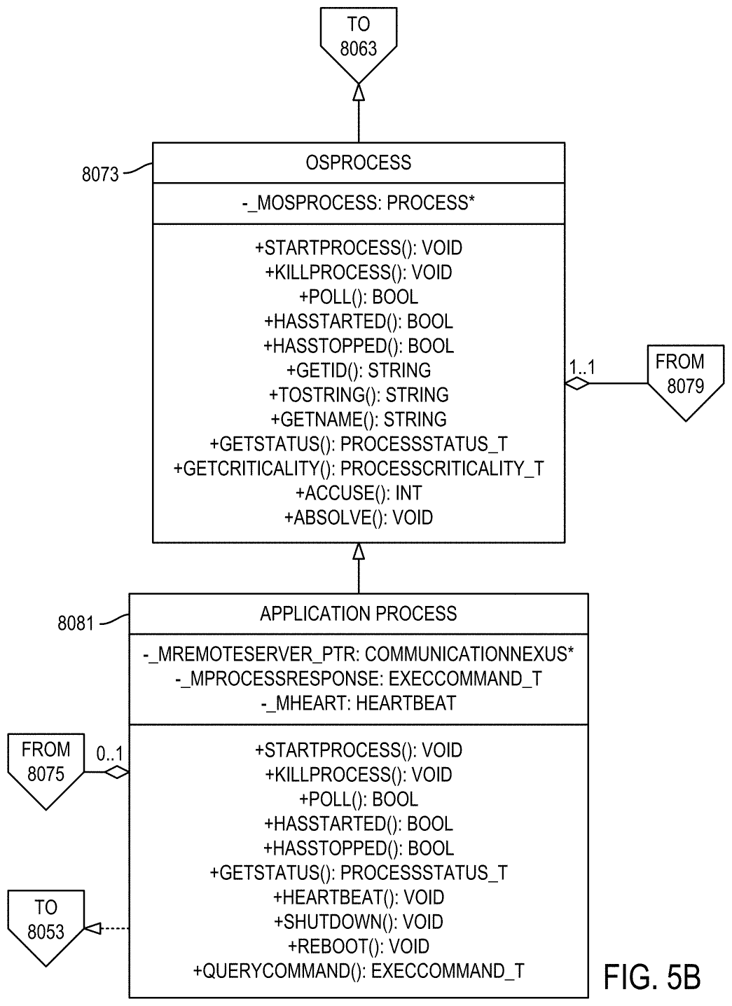

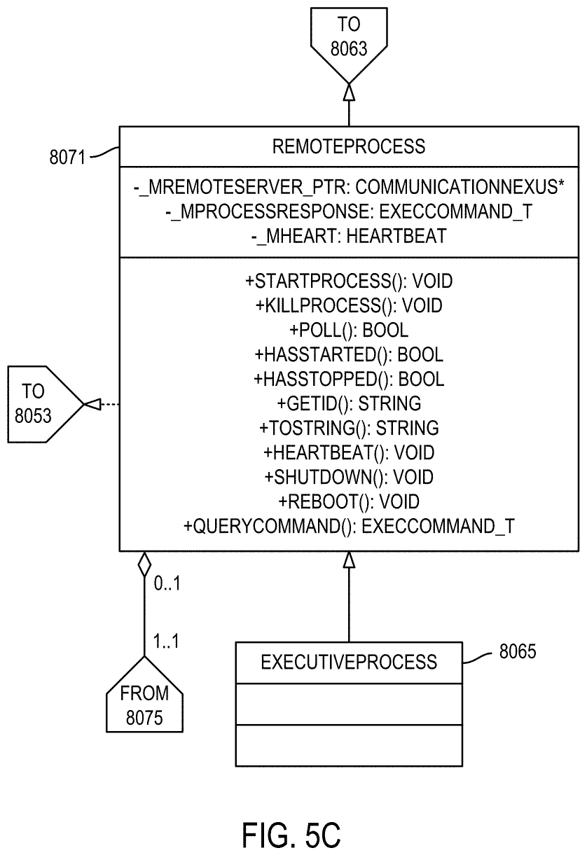

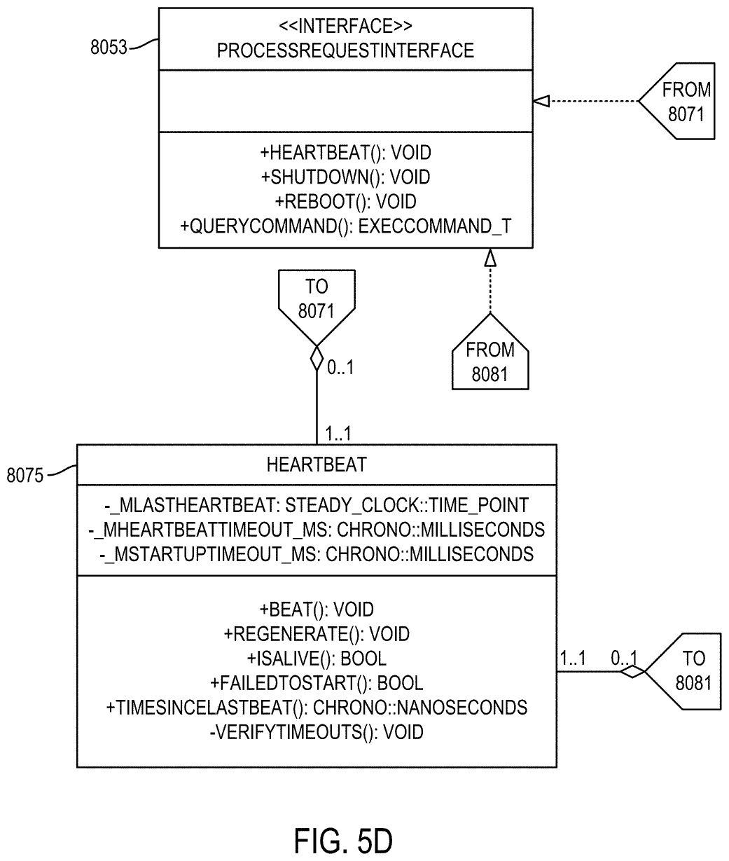

Referring now to FIGS. 5A-5D, process classes represent processes 8063 in varying states, for example, running, stopped, or not yet created. Process classes have the ability to create processes 8063, monitor them, and stop them when necessary. Different kinds of processes 8063 can be represented by process classes. Processes 8063 can be used by the executive state machine to determine, at least in part, current behavior of the executive instance. Some exemplary processes can include remote process, operating system process, executive process, and heartbeat process. Operating system process class 8073 represents processes that execute on the same CPU as executive process 8067, and can allow itself to perform operating system functions such as monitoring and stopping processes. For example, Linux process class 8079 represents processes that execute in a Linux operating system environment. Linux process class 8079 can be used to monitor and stop processes when the executive instances 8065 are executing in a Linux environment. Processes built with the executive client API can take advantage of facilities of operating system process class 8073 and process request interface 8053, and can be registered with communications nexus class 8052 (FIG. 3B). An extra layer of supervision can be added to application process class 8081 by heartbeat class 8075. Processes 8063 created according to applications process class 8081 can be required to call in through communications nexus class 8052 (FIG. 3B) in a timely cadence in order to maintain a status of running. Failure to call in during a pre-selected time period will result in the flagging of process 8063 as not running, even if, as far as the operating system is concerned, process 8063 is still running.

Continuing to refer to FIGS. 5A-5D, remote process class 8071 embodies processes 8063 that execute on a CPU that is remote to the executive instance. Remote processes cannot start a process remotely, but can use process request interface class 8053 to communicate through communications nexus class 8052 (FIG. 3B). Remote processes can be built with the executive client API to enable communication with a remote process through communication nexus class 8052 (FIG. 3B). Remote process class 8071 can monitor the status of remote processes according to whether or not a heartbeat has been received within a pre-selected time period. Remote process class 8071 can stop the remote process by sending a stop command through communications nexus class 8052 (FIG. 3B), which the executive client API can see and act upon in the remote process.

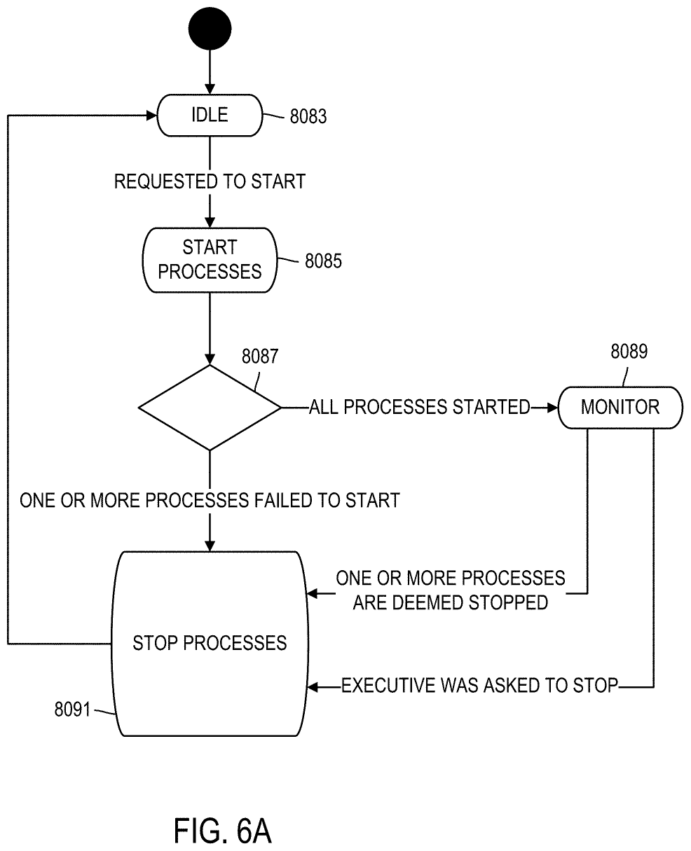

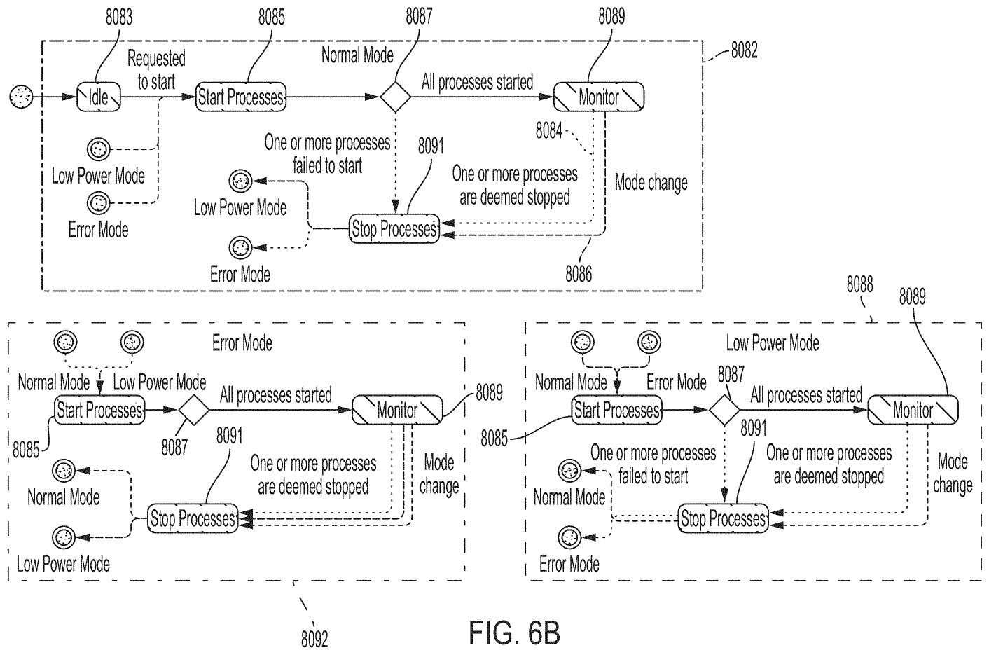

Referring now to FIG. 6A, executive state machine 8101 (FIG. 1A) is responsible for starting and stopping all processes under its domain. It starts in idle state 8083 doing nothing until prompted by an outside command. When a start command is received from an acting executive prime, executive state machine 8101 (FIG. 1A) will transition immediately into start process state 8085. In start process state 8085, executive state machine 8101 (FIG. 1A) will check on the current state of each of its processes and act accordingly. If a process is inactive, executive state machine 8101 (FIG. 1A) will invoke the start process function of that process. If a process is in a fault state, executive state machine 8101 (FIG. 1A) will reset the process to inactive so that it may try to start again. The number of times a process is allowed to attempt a restart can be limited by a pre-selected number, for example, settable in the configuration file. If a process finds itself in the fault state more than the pre-selected number, the executive state machine will transition to stop process state 8091. If a process is in any other state, executive state machine 8101 (FIG. 1A) can check that the process has officially started. When all processes under the auspices of the executive state machine have started, executive state machine 8101 (FIG. 1A) transitions to monitor state 8089.

Continuing to refer to FIG. 6A, in monitor state 8089, executive state machine 8101 (FIG. 1A) can check the processes under its auspices to find out if they are running. If a process is observed to be not running, executive state machine 8101 (FIG. 1A) will stop the observed process if the process is essential. If the stopped process is an essential process, executive state machine 8101 (FIG. 1A) (in monitor state 8089) will report that process and transition to stop process state 8091. If the state machine transitions from the Monitoring state to the Stop Process state without a prompted mode change, then the Executive will set its target mode to the error mode. Executive state machine 8101 (FIG. 1A) can transition to stop process state 8091 as a result of a function call, for example, but not limited to, when executive process 8065 receives a SIGINT. The last reason the Executive state machine would transition to the Stop Process state, is during a mode change. In stop process state 8091, executive state machine 8101 (FIG. 1A) stops all running processes that are being monitored that are not designated to run in the desired mode. If the process is not already stopped, executive state machine 8101 (FIG. 1A) can invoke the process's stop function. When all the processes have stopped if a mode change was not requested, executive state machine 8101 (FIG. 1A) can transition to idle state 8083, ready to be started again if requested. If there was a requested mode change, the state machine will then transition to the Start Process state to continue the cycle.

Referring now to FIGS. 6A and 6B, executive states, as described herein, include, for example, but not limited to, idle, initializing, monitoring, and shutting down. In such a configuration, the executives executing on a LAN are linked together and report to a centralized executive. Each executive is associated with an independent executive state, and the multiple executive states communicate in order to remain synchronized as much as possible during operation. Further, executives associated with executive states begin an execution cycle in an idle state, meaning the executives await directions in the form of files they access or external communications. The files the executive accesses, configuration files, indicate which processes to start. After the configuration file is accessed, the executive transitions into an initialization state, if there are processes to spawn. The executive spawns the processes indicated in the configurations files. After the processes are spawned and acknowledge their status to the executive, the executive transitions to a monitoring state. In monitoring state, the executive monitors the activities of the processes that it has spawned. When, for example, one of the spawned processes unexpectedly stops, or when the power button on the device is depressed, the executive enters shutting down state.

Continuing to refer to FIGS. 6A and 6B, the executive can operate in various running modes, for example, but not limited to, normal mode and error mode. In an arrangement, the default execution mode is normal mode. Processes that are spared are added to the running list of processes in the error mode. Other modes can be added as needed. To add a mode, each process that is to be executing in the mode can be tagged as such, for example, but not limited to, with an XML tag in the process's launch file. Processes can be marked with any number of modes.

Continuing to refer to FIGS. 6A and 6B, when the executive switches between two modes, the executive can bring down all processes that are not slated to run in the mode desired mode. The executive can start any and all processes that are not yet running that are marked to run in the desired mode. This is done by cycling through the shutdown state to stop any unwanted processes, then cycling to the initialization state to then start up the missing processes. Any processes that exist in both the former and desired mode will stay alive during this mode transition.

Continuing to refer to FIGS. 6A and 6B, executive clients instruct the executive network on when to change modes, aside from the error mode. The error mode is the mode that the executive network transitions to when the executive network detects a problem. This error mode houses all of the spared processes and ensures that they are running by relaunching them if they have died due to previous events.

Referring now to FIG. 6B, in some configurations, the executive begins its execution cycle in normal mode 8082, in idle state 8083. In normal mode 8082, the executive accesses configuration files or otherwise determines what its future activities are to entail, for example, the processes it is to spawn. The executive, in start processes state 8085 spawns the processes and transitions to monitoring state 8089 if 8087 all processes started correctly. If 8087 one or more processes failed to start, or when one or more processes is deemed to have stopped 8084, or where there is a mode change 8086, the executive enters stop processes state 8091. If the mode is changed to low power mode 8088, the executive starts processes 8085 in low power mode 8088, and transitions to monitoring state 8089 if 8087 all processes started correctly. If 8087 one or more processes failed to start, or when one or more processes is deemed to have stopped 8084, or where there is a mode change 8086, the executive enters stop processes state 8091. If the mode is changed to normal mode 8082, the executive returns to normal mode 8082 as described herein. If, in either normal mode 8082 or low power mode 8088, the mode is changed to error mode 8092, the executive starts processes 8085 in error mode 8092, and transitions to monitoring state 8089 if 8087 all processes started correctly. If 8087 one or more processes failed to start, or when one or more processes is deemed to have stopped 8084, or where there is a mode change 8086, the executive enters stop processes state 8091. If the mode is changed to normal mode 8082, the executive returns to normal mode 8082 as described herein. If the mode is changed to low power mode 8088, the executive returns to normal mode 8082 as described herein. In an arrangement, all processes are assigned to be in normal mode 8082 to begin with regardless of what is encoded in the configuration files, but the configuration files can assign a mode, possibly different from the normal mode, to any and all processes. In general, when a process requests a mode change, the executive transitions to stop processes state 8091. In an arrangement, stop processes state 8091 spares executing processes that share the same mode as the mode that the executive is transitioning to, and shuts down the other processes. The executive then transitions from stop processes state 8091 to initializing (start processes) state 8085 in order to spawn processes that are associated with the mode to which the executive is transitioning. In an arrangement, if the executive enters shutting down state 8091 without the initiation of a mode change, the executive transitions to error mode 8092, and processes that would be spared are associated with error mode 8092. The executive proceeds with transitioning to shutting down state 8091, sparing the executing processes that share the same mode as the mode the executive is transitioning to, as described herein. Each process can be associated with any number of modes, and modes can be added to the system. To request a mode change, the process must have a required authority to make the request for that specific mode. For example, low power mode 8088 can be requested by a process that is given the authority to make the request by the executive client. To detect that the mode has changed, a process can listen for such changes through interprocess communication facilities well-known in the art.

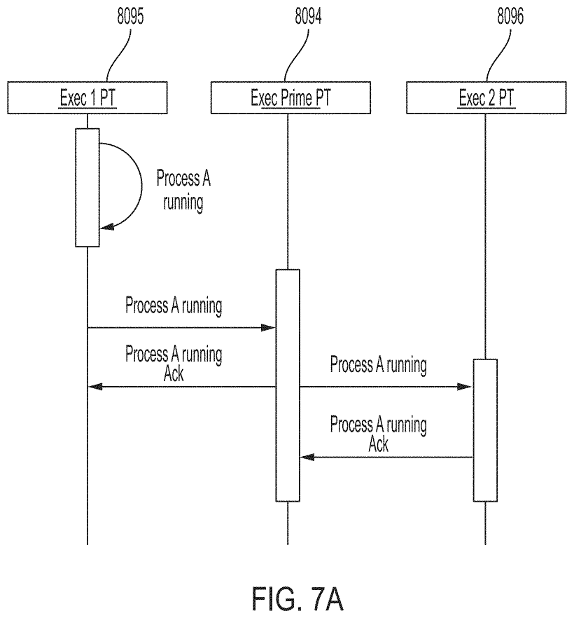

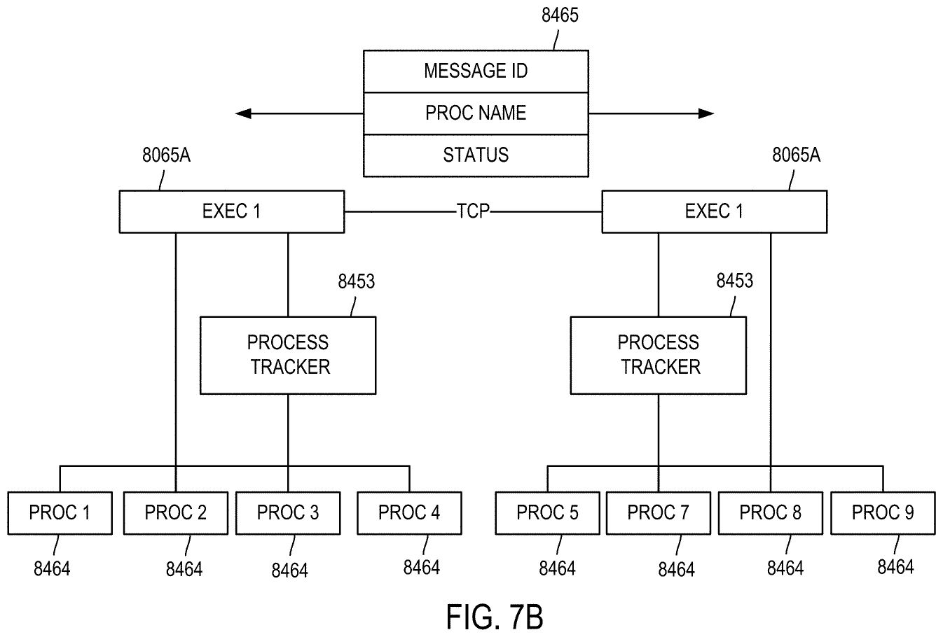

Referring now to FIG. 7A, the process tracker is a module built into all instances of the executive. Its purpose is to keep track of the running status of processes both local and remote on other executives in the network. This is needed because sometimes there are processes that are not configured to start until another process is finished starting. But there is a chance that these two processes exist on two different embedded systems running under two different executives. When a process's status changes on a local executive, it notifies its local process tracker of its name and status. The process tracker will create an entry if the name is new, and record the status of the process if the report came from a local process. Once any process has been updated in the process tracker, the process tracker will add an entry for all known networked executives to be notified of the change. During a communication with Prime or a remote process, the executive will check the notification list from the local process tracker to see if it needs to add these process status changes to the message. When receiving any message from a client or executive prime 8094, the executive 8095/8096 will check for any process changes sent from the other. If there are any, it will send those process updates to the local process tracker with the name of the sender. When updating a process in the process tracker, if the process' status is unchanged and the name of the sender is in the notification list, then the process tracker removes that entry from the notification list since that is confirmation that the remote process has been fully notified of the process change. If the process' status is changed and it is not a local process, then the process tracker adds a notification entry for all other registered executives and updates its own process status for that process. This act will ensure that the process's status will propagate throughout the executive network for others to know about without every executive being connected to one another.

Referring now to FIG. 7B, each instance of executive 8065A includes process tracker 8453. Process trackers 8453 track the running status of all processes 8464 in the system, both local and remote. Processes 8464 across embedded systems can be dependent upon each other. For example, some processes 8464 executing on a first embedded system might need to delay starting until processes 8464 on a second embedded system are running. Process status changes can be recorded locally and a notification entry for all other executives can be made so that the process status information can be propagated, for example, by message 8454, to executives that are not necessarily directly connected to each other.

Continuing to refer to FIG. 7B, when there is a status change of process 8464 on Executive 8065A, executive 8065A notifies process tracker 8453 of the name and status of process 8464. Process tracker 8453 can note the new process, and record the status of the process if the report came from a local process. If process 8464 has been updated in process tracker 8453, process tracker 8453 can indicate that all known networked executives 8065A be notified of the change. During a communication with an executive prime or a remote process, executive 8065A can check the notification list from the local process tracker 8453 to determine if process status changes should be added to the message. When receiving any message from a client or executive prime, executive 8065A can check for any process changes sent from other executives 8065A. If any status changes, executive 8065A can send the status changes to the local process tracker with the name of the process. When updating the status of process 8464 in process tracker 8453, if the status is unchanged and the name of the sender is in the notification list, then process tracker 8453 removes the entry from the notification list since that is confirmation that the remote process has been fully notified of the process change. If the status is changed and the process whose status has changed is not a local process, process tracker 8453 can add a notification entry for all other registered executives 8065A and can update the local process status for that process. Making these updates can ensure that the status change will propagate throughout the network of executives 8065A whether or not all executives 8065A are connected to one another.

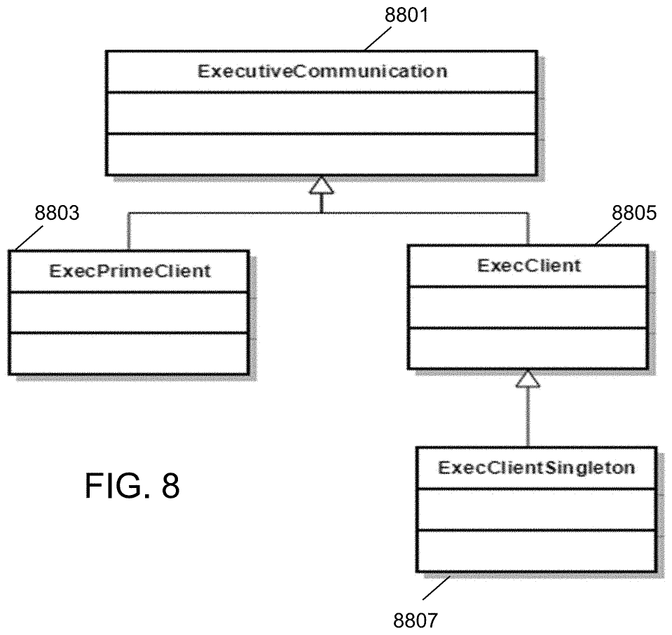

Referring now to FIG. 8, executive communication class 8801 handles sending and receiving data, serializing and deserializing the data, and establishing and maintaining active connections among processes. Executive communication class 8801 also sets up call backs when events happen, for example, if the executive sends a shutdown command or fails to respond to this a process in time.

Continuing to refer to FIG. 8, in an arrangement, executive client class 8805 is used by default by most processes. Executive client class 8805 defines what actions are required when, for example, a shutdown is received by the process, or when the executive has timed out. In such cases, executive client class 8805 shuts down hosting process. Executive client class 8805 class also defines functions for communicating with the executive, such as, for example, but not limited to, the ability to check in and the ability to request a shutdown. The check in function is to be called once per run time loop by the hosting process. The check in function can update the process's proxy on the executive's heart beat so that the executive believes the process to be executing. The ability to request a shutdown enables a process to inform the executive that it needs to be stopped. Executive client class 8805 also provides the ability to generate delegate objects to be used as check in functions for asynchronous tasks that the process holds. The process can request any number of these delegate objects. For every delegate object generated, the executive client object requires that a delegate be called within an allotted time, defined by the hosting process, or else the next call to the main check in function will be blocked. This effectively ties the heartbeat of the process to its asynchronous tasks.

Continuing to refer to FIG. 8, in an arrangement, executive client singleton class 8807 is executive client class 8805 wrapped in a singleton for the benefit of processes that have nodelet managers.

Continuing to refer to FIG. 8, executive prime client class 8803 defines the required actions of the process when the connected executive sends a shutdown request, times out, or experiences other types of terminal behavior, for example. In an arrangement, executive prime client class 8803 can, for example, set a flag to indicate certain types of activities. The flag can be provided to the hosting executive process though a modified version of the check in function that is available to executive client class 8805. In an arrangement, the process sends a heartbeat message to the connected executive, and returns a flag indicating if the hosting executive should continue running. The hosting executive can clean up and shut down all of its monitored processes. Executive prime client class 8803 also provides functionality for the hosting executive to inform the connected executive that the hosting executive is shutting down.

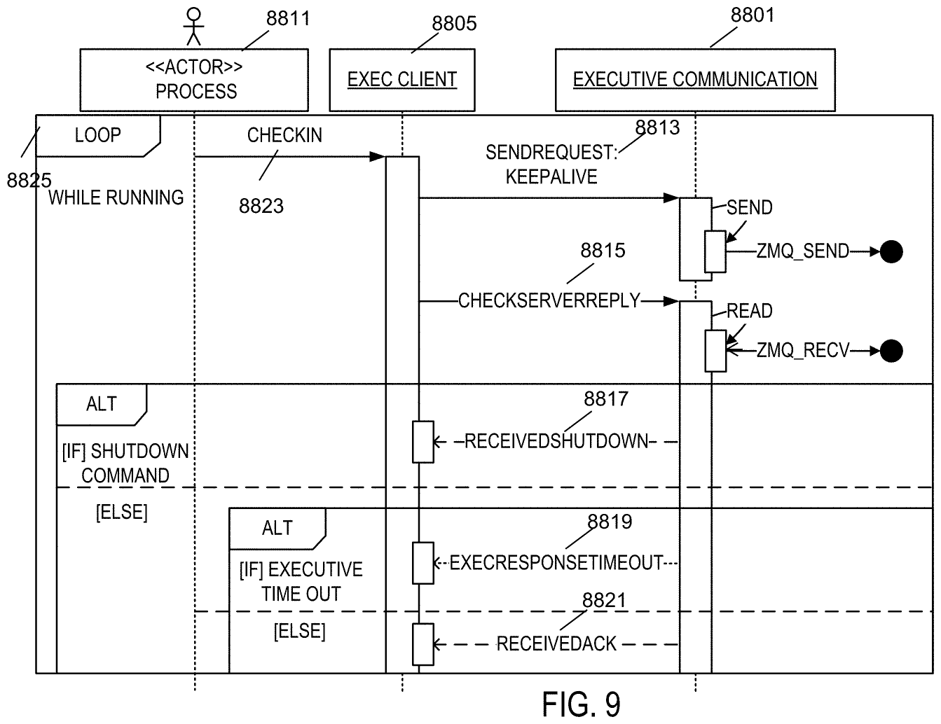

Referring now to FIG. 9, the sequence diagram shows how executive client class 8805 communicates with the executive when called upon by hosting process 8811. Hosting process 8811 invokes checkin function 8823 once per run time loop 8825. When checkin function 8823 is invoked, executive client object 8805 sends a message to the executive and receives the response back. In response to check in function 8823, executive client object 8805 sends heartbeat request message 8813 to executive communications function 8801, which prepares and sends a function call to the executive. Depending on the response from the executive, or lack there of, executive client object 8805 calls one of the pre-defined functions that are dictated by the specialization of executive communication 8801. Executive client 8805 communicates with the executive through executive communications function 8801 when called upon by hosting process 8811. To communicate, executive client 8805 sends a message to executive communications function 8801 when it is prompted by hosting process 8811 (executing under the operating system).

Continuing to refer to FIG. 9, an executive client API can be included in the system of the present teachings to provide access to a library of functionality that is commonly used across the system. In an arrangement, the executive client API is a library that is built into executables and provides functionality that enables processes 8811 to communicate with an executive process. In some configurations, processes 8811 can use a pre-defined class to provide communications between the processes and an associated executive process. In an arrangement, executive client class 8805 can provide communications between processes. In some configurations, other classes can be used for this purpose. In an arrangement, the executive client singleton class 8807 (FIG. 8) can be used for communications, for example, when the process has a ROS nodelet manager that effectively runs multiple processes concurrently under one process in order to quickly share resources. Executive client singleton class 8807 (FIG. 8) can be referenced by the same multiple processes as executive client class 8805 (FIG. 8). In an arrangement, executive client prime class 8803 (FIG. 8) is used by executive processes to communicate among each other. Executive communication class 8801 includes functions to manage sending and receiving data, serializing and deserializing the data, and establishing and maintaining active connections between the executive client and the executive. In an arrangement, messages that can be sent through use of executive communications class 8801 can include, but are not limited to including, a message 8817 noting that a shutdown request has been received, a message 8819 noting that the executive recognized a message timeout, and a message 8821 that a message acknowledgment was received. Messages that can be received through use of executive communications class 8801 can include, but are not limited to including, a heartbeat message 8813, and a command message 8815 to check a server reply.

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software for accomplishing the methods discussed herein, and computer readable media storing software for accomplishing these methods. The various modules described herein can be accomplished on the same CPU, or can be accomplished on different computers. In compliance with the statute, the present configuration has been described in language more or less specific as to structural and methodical features. It is to be understood, however, that the present configuration is not limited to the specific features shown and described, since the means herein disclosed comprise preferred forms of putting the present configuration into effect.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A method for managing processes executing on a plurality of embedded systems comprising:
establishing an executive, a process tracker, and at least one process on each of the plurality of embedded systems, the at least one process marked as an essential process in pre-selected circumstances;
receiving, by each of the executives, at least one configuration file;
establishing communications among each of the executives;
tracking a status, by each of the process trackers, of each of the at least one process across the plurality of embedded systems;
starting up the at least one process, by the executives, on the plurality of embedded systems according to the at least one configuration file; and
shutting down, by the executives, each at least one process of the plurality of embedded systems if at least one of the essential processes achieves a pre-selected status.

2. The method as in claim 1 further comprising:
denoting one of the executives as a prime executive.

3. The method as in claim 2 further comprising:
monitoring a heartbeat message from the prime executive.

4. The method as in claim 2 further comprising:
informing the prime executive when the shutting down step is occurring.

5. The method as in claim 1 wherein at least one of the plurality of embedded systems comprises:
a communication computer.

6. The method as in claim 1 wherein at least one of the plurality of embedded systems comprises:
a perception computer.

7. The method as in claim 1 wherein at least one of the plurality of embedded systems comprises:
a path planning computer.

8. A system for managing activities among a plurality of embedded systems comprising:
a management executive associated with each of the plurality of embedded systems;
a communication system enabling each one of the management executives to communicate with others of the management executives;
at least one configuration object, the configuration object being configured to be exalted by the management executive when a pre-selected set of execution prerequisites is met;
at least one managed process configured to execute in an associated one of the plurality of embedded systems, the at least one managed process being identified by the at least one configuration object, the at least one managed process being associated with one of the plurality of embedded systems, at least one state of the at least one managed process being monitored by the management executive, at least one of the managed processes being identified as essential,
wherein each of the management executives configured to enter a shut down state when at least one of the essential processes has failed.

9. The system as in claim 8 further comprising:
an executive prime chosen from the management executives executing in each of the plurality of embedded systems.

10. The system as in claim 8 wherein the management executives are configured to execute in states comprising:
idle state;
initializing state;
monitoring state; and
shutting down state.

11. The system as in claim 8 wherein the management executives are configured to execute in modes comprising:
normal mode;
low power mode; and
error mode.

12. The system as in claim 8 wherein the management executives comprise:
a process tracker tracking a running state of the at least one managed process, the process tracker enabling dependencies among a plurality of the at least one managed process across the embedded systems.
